(19) United States
(12) Patent Application Publication
(10) Pub. No.: US 2007/0268368 A1
(43) Pub. Date: Nov. 22, 2007

(54) Activity based persistent recording

(76) Inventor: William Silvernail Bradford, Raleigh, NC (US)

Correspondence Address: John L. Sotomayor, Suite 300, 511 Davis Drive, Morrisville, NC, 27560, US

(21) Appl. No.: 11/434,773

(22) Filed: May 17, 2006

(51) Int. Cl. H04N 7/18

(52) U.S. Cl. 348/148; 348/159

(57) ABSTRACT

A system and method for continuous recording of an integrated data stream from audio, video, and sensor devices from a digital video recording system installed within a mass transit vehicle. The digital video recording system contains a covert camera and timers that initialize data recording after the ignition is turned off within a vehicle, when acts of vandalism destroy or obscure the data stream from visibly mounted cameras, or when motion is detected within the vehicle where there should be none. The invention includes timers that may be set for known periods of time, or set to progressively extend recording as needed.

### TECHNICAL FIELD

The instant invention is concerned with persistence in the recording of video information within a mass transit vehicle. Current analog and digital video recording systems are vulnerable to disruptions in electrical supply and to tampering by vandals or other unscrupulous transit users.

### BACKGROUND

If the primary video cameras of a video surveillance system installed within a mass transit vehicle are vandalized or the vehicle has turned off power, the system is no longer capable of collecting and documenting video evidence or capable of supporting live remote viewing. The instant invention provides a system and process for continuing persistence in video recording regardless of tampering or power supply issues.

### SUMMARY OF THE INVENTION

The instant invention is a system and process for maintaining the persistence of video recording within a mass transit vehicle regardless of acts of vandalism or problems with electrical supply. The system is a multi-camera digital video recording system that is installed within said mass transit vehicle. The system is installed such that standard-sized cameras provided with the system are installed in visible locations within said mass transit vehicle, and the electrical power supply for the installed system is attached directly to the power supply of said mass transit vehicle and may also include a battery backup power supply. The digital video recording system is also typically wired to stop and start recording based on the operation of the mass transit vehicle ignition switch position.

In the preferred embodiment, the installed multi-camera digital video recording system will include a covert camera and covert camera port. The covert camera is oriented forward to record video of the aisle forward of the covert camera and next to the driver seat. The covert camera is wired to the battery backup and a control circuit. When the mass transit vehicle power supply is terminated, such as when the ignition switch is turned off, the control circuit senses this condition and supplies power to the covert camera to continue recording for a pre-set, user configurable period of time. If there are no disturbances, the covert camera discontinues recording and turns off at the end of the pre-set time period. Likewise, if the primary camera are vandalized such that all normal visual information is obscured, continued activity on the mass transit vehicle, as detected by the covert camera, will cause data recording to continue.

If, however, a disturbance occurs, as recorded by a motion sensor within the mass transit vehicle, the control circuit resets the recording timer and the covert camera continues to record and store data. The motion sensor may be installed as a separate device and electrically connected within the system, or may consist of a motion sensing function of the covert video camera.

The installed system continues to operate after loss of vehicle power providing live, integrated streaming video that is available via wireless communication connection to aid law enforcement agencies to respond to situations as they occur on a mass transit vehicle. The installed covert camera and battery backup power supply of the instant invention combine to provide a continuous record of data within a mass transit vehicle for later evidentiary use by authorized law enforcement agencies.

### BRIEF DESCRIPTION OF THE FIGURES

FIG. 1: System Component Diagram

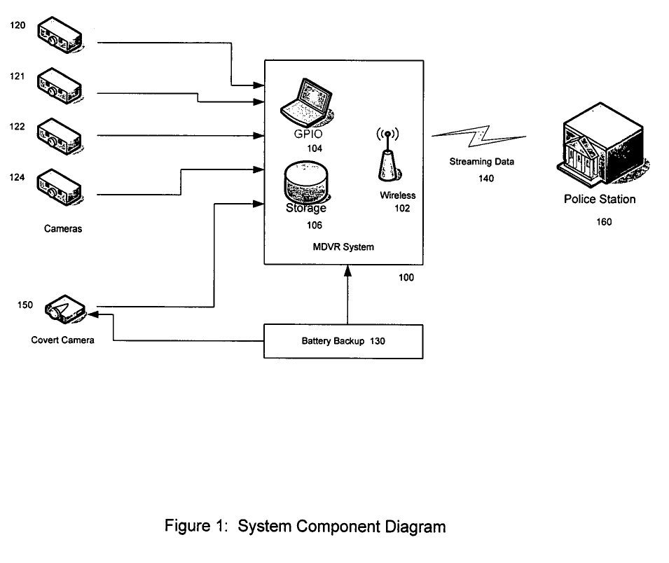

FIG. 2: Process Flow Diagram

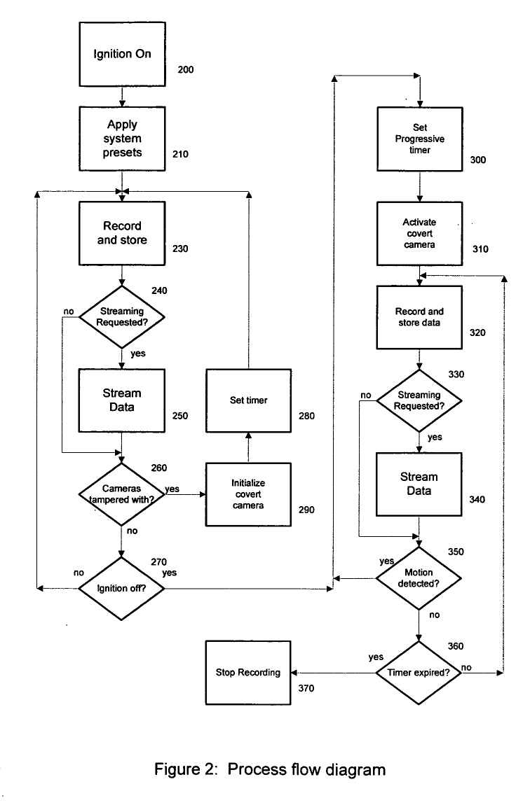

### DETAILED DESCRIPTION OF THE INVENTION

The instant invention is a system and process for maintaining the persistence of video recording within a mass transit vehicle. The system is installed with a multi-camera digital video recording system 100 that is installed within said mass transit vehicle. The system is installed such that standard-sized cameras (120-124) provided with the system are installed in visible locations within said mass transit vehicle, and the electrical power supply for the installed system is attached to the power supply of said mass transit vehicle and may include a battery backup power supply 130. The installed multi-camera digital system 100 also contains a sensor that provides an indication of whether the ignition of the mass transit vehicle is off or on. In addition, the installed system contains a General Purpose Input/Output (GPIO) 104 microprocessor that monitors the ignition sensor, monitors power to the cameras (120-124), provides timer functions to the system, and monitors an integral motion detector, in addition to other functions.

In the preferred embodiment, the installed multi-camera digital video recording system will include a covert camera 150 and covert camera port, and a motion detector integral to the covert camera 150. The covert camera 150 is oriented forward to record video of the aisle forward of the covert camera 150 and next to the driver seat. The covert camera 150 and integral motion detector are wired to battery backup 130 and a control circuit within the GPIO 104 containing a rules engine for programmatic control and administrative setup of the system.

When the mass transit vehicle power supply is terminated, such as when the ignition switch is turned off 270, the control circuit senses this condition and supplies power to the covert camera 150 and integral motion detector. The control circuit contains a timer that is initialized 210 upon the control circuit receipt of an ignition off condition 270 to continue recording from the covert camera 150. The timer measures a pre-set, user configurable period of time to continue recording. If there are no disturbances, the covert camera 150 discontinues recording and turns off at the end of the pre-set time period 370.

After the ignition off 270 and upon the receipt of a signal from the motion detector or the motion detection function of the camera, the system registers the receipt of said signal as a disturbance. The disturbance triggers a reset of the timer 280 within the control circuit. The timer reset 280 returns the timer to zero and the covert camera 150 continues to record data for the length of time to which the timer has been pre-set. If no further disturbance is detected, the covert camera 150 records data for the pre-set duration of the timer and, once again, discontinues recording and turns off 370. However, each time a disturbance occurs, as measured by the receipt of additional signals from the motion detector 350, the timer is once again reset and the covert camera 150 continues to record data.

Also, in the preferred embodiment the reset value for the timer can be progressive instead of pre-set. In this mode, the first time a signal from the motion detector 350 triggers a timer reset the timer is reset to an initial value selected by the user of the system 300. Each subsequent motion detector signal triggers a reset timer with a time limit that is a multiple of the initial value 300. In this way, as additional disturbances are registered by the motion detector the system will be sure to remain in active mode long enough to capture data for the entire duration of the disturbance.

The preferred embodiment also contains a means for communicating the current system status, in the event of a disturbance, to an entity exterior to the mass transit vehicle, such as transit security personnel or an official police entity 160. The system may use Wireless WAN 102 remote access or normal WiFi as communication channels for communication to the exterior agents. Either communication channel provides for exterior capture of the video data collected by the covert camera 150 and streamed (250, 340) to exterior agents or agencies 160 in realtime during the period of disturbance.

Thus the instant invention is installed within mass transit vehicles to solve the issues of vandalism of internally mounted cameras (120-124), the loss of internal power within the mass transit vehicle, while still allowing the recording system to shut off normally when there are no disturbances, thus conserving battery power and storage space. This combination of capabilities meets the need of law enforcement agencies for continuous and current video data delivered remotely to view and assess an ongoing disturbance, or to provide documented data for later evidentiary use.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A system for continuous recording of data within a vehicle after the termination of normal vehicle operation, comprising:
a digital video recording system comprising at least a microprocessor, digital storage, a power supply connection, a communications channel, and at least two cameras;
a backup battery power supply;
at least one motion detection sensor capability;
at least one software module stored within said microprocessor;
wherein said at least one software module remains persistent and continues to operate at least one camera after normal operation of the system ceases to record and store an integrated data stream of video, audio, and sensor data of conditions within said vehicle.

2. A system according to claim 1 for continuous recording of data within a vehicle after the termination of normal vehicle operation, further comprising:
said digital storage comprises any portable electromagnetic storage including but not limited to flash memory, random access memory chips, and detachable auxiliary memory storage devices.

3. A system according to claim 1 for continuous recording of data within a vehicle after the termination of normal vehicle operation, further comprising:
said power supply connection attaches the vehicle power supply to said digital video recording system;
said backup battery power supply is connected to said digital video recording system;
wherein said backup battery power supply is connected in such a fashion that it begins operation only when said vehicle power supply is turned off.

4. A system according to claim 1 for continuous recording of data within a vehicle after the termination of normal vehicle operation, further comprising:
at least one camera mounted visibly within said vehicle, and at least one covert camera mounted in such a fashion as to be unseen by users of the vehicle;
wherein said covert camera is operational for a pre-set period of time after said vehicle power supply is terminated, or after said visible camera(s) have been disabled and are no longer recording and storing data, or upon direction from said software module within said microprocessor.

5. A system according to claim 1 for continuous recording of data within a vehicle after the termination of normal vehicle operation, further comprising:
said communication channel connects said vehicle to an outside agency through a wireless Wide Area Network or WiFi connection.

6. A system according to claim 1 for continuous recording of data within a vehicle after the termination of normal vehicle operation, further comprising:
said at least one software module is stored within non-volatile magnetic memory within said microprocessor;
wherein said at least one software module senses a vehicle power off condition, directs the switch to said backup battery power supply, sets at least one timer, receives data from said motion detection sensor, and initializes and operates said covert camera to continue recording and storing data in accordance with timer presets and sensor conditions within said vehicle.

7. A method for continuous recording of data within a vehicle after the termination of normal vehicle operation comprising the following steps:
initializing software modules within a digital video recording system to set timers, sensors, and system operation functions;
receiving data from said sensors;
detecting vehicle ignition off, motion detection, and equipment disabled conditions;
managing timers to provide continuous data stream collection and storage according to said detection of said vehicle ignition off, motion detection, and equipment disabled conditions;
communicating with an agency external to said vehicle;
wherein said software modules provide continuous data recording and storage of an integrated data stream comprising audio, video, and sensor data of events occurring within said vehicle under programmatic control for the duration of any and all of said timers.

8. A method according to claim 7 for continuous recording of data within a vehicle after the termination of normal vehicle operation further comprising:
receiving data from said sensors includes receiving data from at least an ignition off sensor, a motion detection sensor, and camera video feed indicators.

9. A method according to claim 7 for continuous recording of data within a vehicle after the termination of normal vehicle operation further comprising:
said communicating with an agency external to said vehicle comprises streaming data from said digital video recording system over a wireless communication channel.

10. A method according to claim 9 for continuous recording of data within a vehicle after the termination of normal vehicle operation further comprising:
said wireless communication channel comprises a Wide Area Network or WiFi connection.

11. A method according to claim 7 for continuous recording of data within a vehicle after the termination of normal vehicle operation further comprising:
said system operation functions comprise recording and storage of data collected by the digital video recording system cameras, polling and receiving data from sensors, managing data collection and forwarding, and system shutdown.

12. A method according to claim 7 for continuous recording of data within a vehicle after the termination of normal vehicle operation further comprising:
wherein said timers may comprise a progressive timer for non-linear extension of time periods of operation.
